(19) United States
(12) Patent Application Publication
(10) Pub. No.: US 2015/0359194 A1
(43) Pub. Date: Dec. 17, 2015

(54) AUTOMATED PET TOYS AND RELATED METHODS

(71) Applicant: Victoria Coopman, Cedarpines Park, CA (US)

(72) Inventor: Victoria Coopman, Cedarpines Park, CA (US)

(21) Appl. No.: 14/736,566

(22) Filed: Jun. 11, 2015

Related U.S. Application Data
(60) Provisional application No. 62/012,169, filed on Jun. 13, 2014.

(51) Int. Cl. A01K 15/02

(52) U.S. Cl. CPC A01K 15/025; A01K 15/024

(57) ABSTRACT

Automated pet toys are disclosed having a movable lure to solicit reaction by a pet. Exemplary pet toys include a toy housing, an electronic motor contained within the toy housing, a drive mechanism that includes a motor, a member with a first end and a second end attached at the first end to the drive mechanism; and a visually attractive lure attached to the second end of the member. Wherein the member protrudes through a slot formed with the toy housing and is movable within the slot. The visually attractive lure can also travel inside a tubing and be moved by air pressure.

### FIELD OF ART

The present invention generally relates to pet toy assemblies or pet toys and related methods. Specifically, the assemblies, systems, and methods of the present disclosure relate to automated pet toys.

### BACKGROUND

Cats and other pets have a deep-seated natural predatory instinct. The oldest, simplest, most efficient and most beloved cat toy of all time is the moving string. According to many cat lovers, there is no domestic cat that does not love to chase a moving string. This activity brings out, reinforces, and satisfies their ingrained urge to hunt. Even the oldest, laziest cat is enticed by a moving string. Although numerous types of string toys and techniques for playing with cats are well known, they all entail a human having to move the string.

Although everyone with a cat also has a string of some sort in his or her home and therefore can readily engage the cat in activity, a “playmate” must move the string in order to entertain the cat. This task can get quite monotonous and boring. In addition, many cat owners do not have the necessary time to engage their cats in healthy amounts of playtime.

Various automated cat and pet toys are known in the art. However, those in the art do not take advantage of the animals' predatory instincts for seemingly random moving toys. Further, they often do not take advantage of the increased animal interest in toys that appear and disappear from an animal's sight.

### SUMMARY

Aspects of the present disclosure include various features described in the detailed section and depicted in the drawing figures and their combinations. Features of the present disclosure include an automated pet toy comprising: a base; an electronic motor contained within the base; a cam attached to the motor; a member comprising a first end and a second end attached at the first end to the cam; and a lure attached to the second end of the member; wherein the member protrudes through a slot formed with the base and is movable within said slot according to a pattern defined by the cam.

A further feature of the present disclosure includes an automated pet toy comprising; a base; an electronic motor contained within the base; a gear attached to the motor; a belt forming a loop having a first end and a second end with the first end driven by the gear; a support wheel driven by the belt at the second end of the belt; a member having a first end and a second end and wherein the first end is attached to the belt; and a lure attached to the second end of the member; wherein the member protrudes through a slot formed in the base, the slot comprising two enlarged end points, and the lure moves within said slot.

A still further aspect of the present disclosure includes an automated pet toy comprising: a housing having an interior cavity defined by a first wall and a second wall located in opposing relationship to the first wall, which has an opening; a drive mechanism located inside the interior cavity; an attachment member connected, directly or indirectly, to the drive mechanism to be moved by the drive mechanism; said attachment mechanism passing through the opening of the first wall and having a section including a free end located inside the interior cavity and a section located external of the interior cavity above the opening; and a lure connected to the free end of the attachment member to be moved by the attachment member.

The automated pet toy wherein the opening can be a slot, a slot connected to a hole having a dimension larger than the slot, or a hole having at least one of a round shape, an oval shape, an irregular shape, and a polygonal shape.

The automated pet toy wherein the attachment mechanism can have a motion pattern that is along a single axis, along a single plane, or along a circular path.

The automated pet toy wherein the attachment mechanism can be flexible and can have a vertical displacement pattern.

The automated pet toy wherein the lure can be disconnectable and connectable to the attachment device.

The automated pet toy wherein the lure can have one or more feathers.

The automated pet toy wherein the housing can include a scratching pad on an exterior surface.

The automated pet toy wherein the scratching pad can be made from at least one of carpet, sisal rope, rubber mat, and cardboard material.

The automated pet toy wherein the second wall can be a base having a generally planar surface.

The automated pet toy wherein the opening can be a first opening and the apparatus can further comprise a second opening spaced from the first opening and a second lure connected to a second attachment member, which has a section extending through the second opening.

The present disclosure further includes a method of using an automated pet toy. The method can comprise the steps: activating a switch to turn on power to a drive mechanism located inside an interior cavity of a toy housing having an opening on a first wall; said driving mechanism driving, directly or indirectly, an attachment member having a section including a free end located inside the interior cavity and a section located external of the interior cavity above the opening; said attachment member moving a lure connected to the free end of the attachment member; and wherein said lure moves along a single axis, along a single plane, along a circular path, or combinations thereof.

The method can further comprise the step of presenting the automated pet toy to a household pet.

The method wherein the lure can be a first lure and the method can further comprise removing the first lure from the attachment member and connecting a second lure to the attachment member.

The method wherein the attachment member can be a tether and wherein the tether is flexible and displaces the lure in a vertical direction.

The method wherein the housing can include a scratching pad on an exterior surface.

The method wherein the opening can be a slot, a slot connected to a hole having a dimension larger than the slot, or a hole having at least one of a round shape, an oval shape, an irregular shape, and a polygonal shape.

The method wherein the scratching pad can be made from at least one of carpet, sisal rope, rubber mat, and cardboard material.

The method wherein the drive mechanism can comprise a cam.

The method wherein the lure can comprise a feather.

A still further aspect of the present disclosure includes an automated pet toy comprising: a housing having an interior cavity defined by a first wall and a second wall located in opposing relationship to the first wall, which has an opening comprising a hole; a drive mechanism located inside the interior cavity comprising a batter operated motor; an attachment member connected, directly or indirectly, to the drive mechanism to be moved by the drive mechanism; said attachment mechanism having a section including a free end located inside the interior cavity and a section located external of the interior cavity above the opening; a lure simulating an animal connected to the free end of the attachment member to be moved by the attachment member; and wherein the drive mechanism is sized and shaped to move the lure generally along a single plane or a single axis to move the lure at least partially out of the hole from the interior cavity and at least partially into the interior cavity.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 shows an automated pet toy with a toy object that simulates an animal entering a hole.

FIG. 2 shows an automated pet toy with a toy object that simulates an animal emerging from a first hole then transiting to and entering a second hole.

FIG. 3 shows the automated pet toy of FIG. 2 with the simulated animal transiting between the first and second holes.

FIG. 4 shows the automated pet toy of FIG. 2 with the animal in the process of entering the second hole.

FIG. 5 shows an automated pet toy that causes a member with a visually attractive attachment mounted to an end to move from side to side and up and down in combination.

FIG. 6 shows the automated pet toy of FIG. 5 with the toy object in a lower right position.

FIG. 7 shows the automated pet toy of FIG. 5 with the toy object in a raised right position.

FIG. 8 shows the automated pet toy of FIG. 5 with the toy object in a raised position.

FIG. 9 shows an alternative automated pet toy similar to that of FIG. 5 with two visually attractive lures mounted on two attachment members simulating two movable animals.

FIG. 10 shows an embodiment of an automated pet toy that rotates in a circle above a scratching post.

FIG. 11 shows an alternative embodiment of the automated pet toy of FIG. 10.

FIG. 12 shows an alternative automated pet toy having an object in a tube wrapped around a scratching post.

FIG. 13 is a schematic diagram of an automated pet toy provided in accordance with aspects of the present disclosure showing a drive mechanism.

### DETAILED DESCRIPTION

The detailed description set forth below in connection with the appended drawings is intended as a description of the presently preferred embodiments of automated pet toys provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

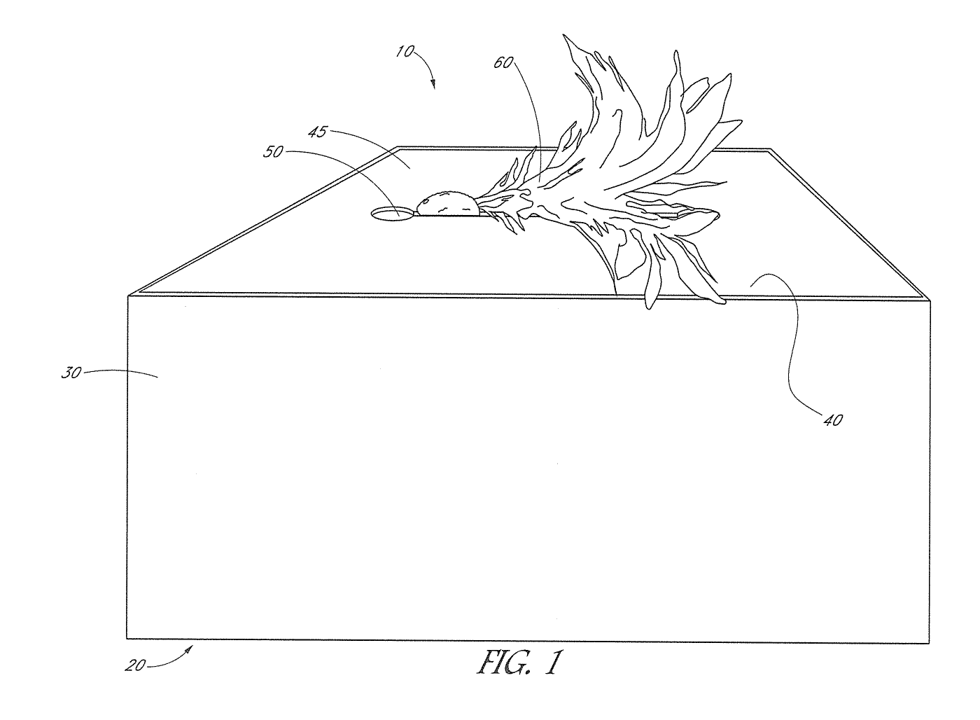

FIG. 1 shows an automated pet toy 10 mounted to a base 20. In the present embodiment, the base 20 embodies a box 30, which can also be considered a toy housing, having a cardboard scratching pad 40 for use by pets, such as household cats. In some embodiments, the base 20 can embody a column, a rectangular prism, a cylinder, a truss, a conically shaped structure, or other shaped structures having a stable surface for supporting a toy and movable mechanisms for moving the toy. The base 20 can be part of the toy housing 30 as shown having a cavity for accommodating moving mechanisms or a drive system for moving one or more simulated animals or objects, as further discussed below.

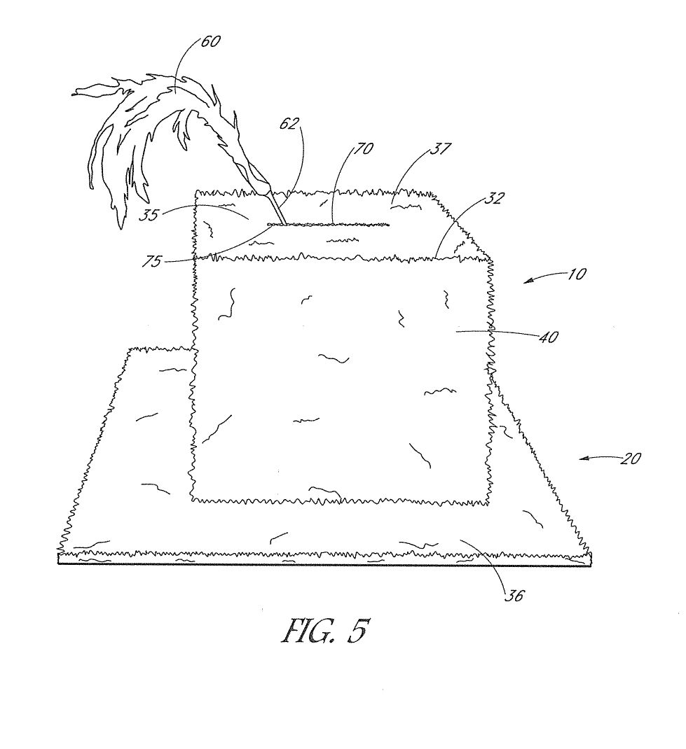

In an integrated embodiment, the side or surface of the toy housing that contacts a support surface, such as the floor or a table top, can be the base. In other examples, the base 20 embodies support platform and the box or toy housing 30 is mounted to the support platform, as shown in FIG. 5. The support platform can embody a generally planar surface or can embody other shapes having a stable support. The base 20 should be sufficiently sturdy to help the toy housing 30 resist tipping. The various bases can have multiple sides, including a round surface or a spherical surface, and can be made from plastic, cardboard, wood, or metal and can be assembled together to have any of the indicated shapes, such as a square or rectangular box 30. Alternatively, the toy housing 30 can have any of the indicated shapes for mounting onto a separate base, which can have a support platform having a planar surface.

The various bases 20 and/or the toy housing 30 can be covered with an over layer, such as carpet, in sisal rope, rubber mat, or any combination of materials to serve as a scratching pad. Any conventional securement means may be used to attach the over layer to the toy housing, such as adhesive, snap buttons, stitching, etc. In some examples, the over layer is a coat applied to a base 20 and/or the housing 30. In some examples, the over layer is applied to less than all sides of the base and/or housing. For example, the base 20 and/or housing 30 can have six sides, such as being a square box, and only one or up to five of the sides are covered with an over layer. In other examples, all the sides are covered with the over layer. The base 20 and/or the housing 30 can be made from separate sections that are then assembled to form the structure for the automated pet toy. The housing sections can include one or more removable panels to facilitate repair, assembly, and battery installation and replacement. The size and shape of the toy housing 30 can be selected to present a sufficiently substantial structural feature to attract a household pet.

A hole, aperture, or opening 50 is provided at aside or top 45 of the base 20 to simulate a hole that an object or animal, such as a rodent, a squirrel, or a mouse, might enter. In some examples, the opening can be incorporated in any of the wall surfaces and not be limited to the top. In an example, the top 45 is provided with an over layer; which can be a carpet, sisal rope, rubber mat, or any combination of materials. In the present embodiment, a visually attractive or catchy toy object 60, also simply called a toy or a lure, connected to a free end of a tether can enter and exit the hole 50. The tether can be connected directly or indirectly to a drive mechanism, such as a motor (not shown) with a cam attachment (not shown), and the drive mechanism causes the tether to move along a path to cause the toy object or lure 60 connected to the free end of the tether or attachment member to move. The tether can be rigid and not flex or be semi-rigid and flexes. When the tether is moved by the drive mechanism and the tether flexes as it moves, the tether can cause the toy object or lure 60 to jerk as it moves in the regular or irregular pattern to simulate a motion that differs from when the tether is rigid. The cam attachment, if incorporated in the drive mechanism, causes the visually attractive lure 60, in this embodiment a mouse but can embody any number of animals such as a squirrel, a rabbit, a lion, etc., to move in a pattern defined by the cam surface or structure. The moving pattern can be regular or irregular, uniform or random.

In some examples, the toy object or lure 60 simply rises straight up and out of the hole 50 and straight down into the hole 50, either completely into the hole or partially into the hole. For example, for every rotation of the motor of the drive mechanism, the toy object 60 is raised out of the hole 50 and then completely or partially moved back into the hole. The toy object 60 can be moved along a single plane or a single axis. In other examples, the toy object can move along multiple planes or multiple axes. The drive mechanism causes the toy object or lure 60 to dip partially or completely into the hole 50 and then popping back out the hole to present a moving toy target or object for the household pet to chase, touch, grab, or catch. In some examples, the hole 50 is generally round. In other examples, the hole 50 has an oval shape, a square shape, an elliptical shape, a semi-spherical shape, an irregular shape, a polygonal shape, or other multi-sided shapes. The toy object 60, which can be soft, pliable, and compressible, can be larger than the dimension of the hole 50, the same size as the hole, or be smaller in size than the hole.

In some embodiments, the toy 60 may be presented in other forms, for example, a bird, a ball, other animals, and other inanimate objects, such as a hat, a shoe, a feather, or a sheet of fabric or paper, to name a few non limiting examples. The toy object 60 can be made from a fabric material and stuffed with soft or pliable material, like a stuffed animal. The toy object 60 can instead be made of a more durable material, such as from an elastic material, an elastomeric material, a thermoplastic material, or a thermoplastic elastomer (TPE), or a combination of fabric and the more durable material. Different color combinations may be used especially bright colors can be used so that the toy object 60 stands out from the environment the toy is located. In some examples, the toy object 60 can include feather or feather-like materials to enhance the visual attractiveness of the toy for the household pet. In one example, the toy object is provided with furry-like coat and a tail to simulate a mouse. The toy object 60 can also include a whistle or other sound generating devices, such as a speaker connected to a circuit board that reacts to movement or touch. The sound generating device will emit sound when touched or grabbed by a pet. The toy object 60 can also be equipped with light that turns on and/or off when touched by the pet. The light can be one or more LED lights. The lights can be controlled to generate different color patterns.

In some examples, the toy object 60 is removable from the tether. For example, threads, snap fit, detents, or other removable engagement means may be used to connect the toy object to the tether. This options allows the pet owner to replace the toy object 60 with another and/or a different toy object to change the appearance of the automated pet toy 10, and possibly to keep the household pet from getting bored with the toy or to simply replace the toy object with a newer or a replacement toy object. Thus, an aspect of the present disclosure is understood to not only include an automated pet toy 10 as shown and described but individual toy objects that can be played by the household pet and for replacing the toy object on the automated pet toy with a different toy object.

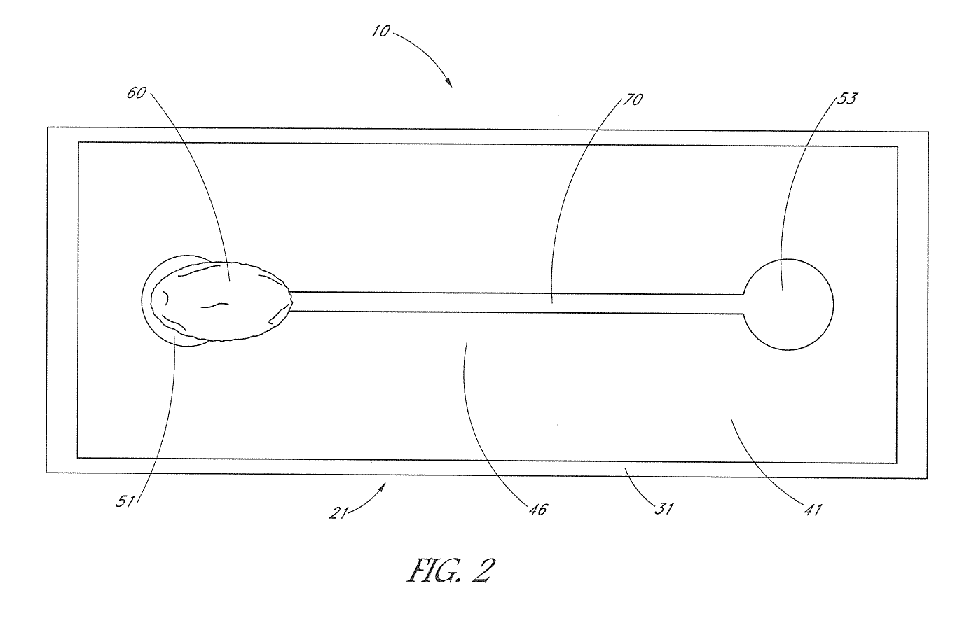

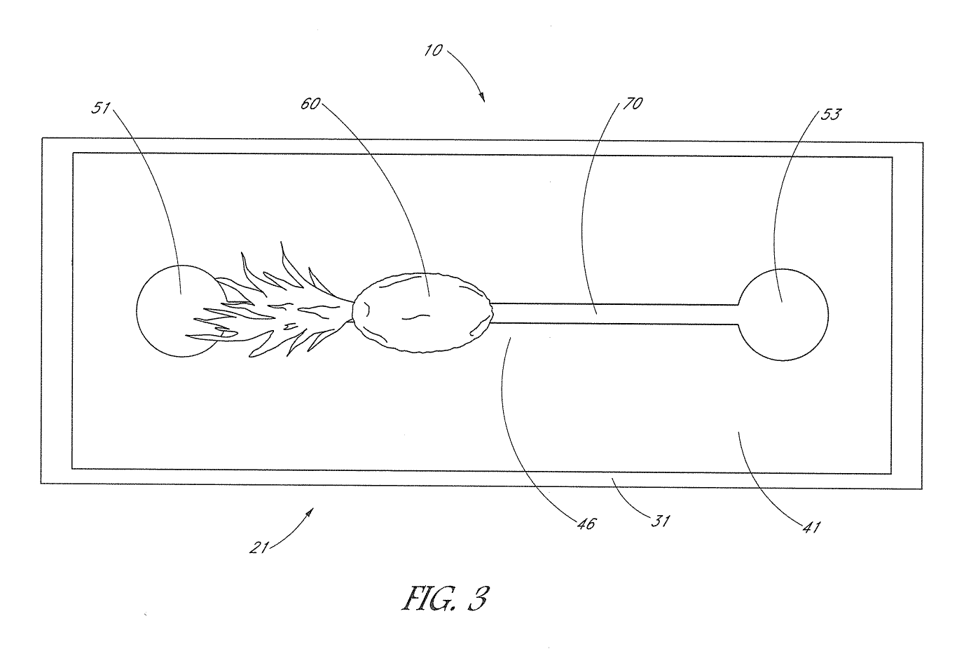

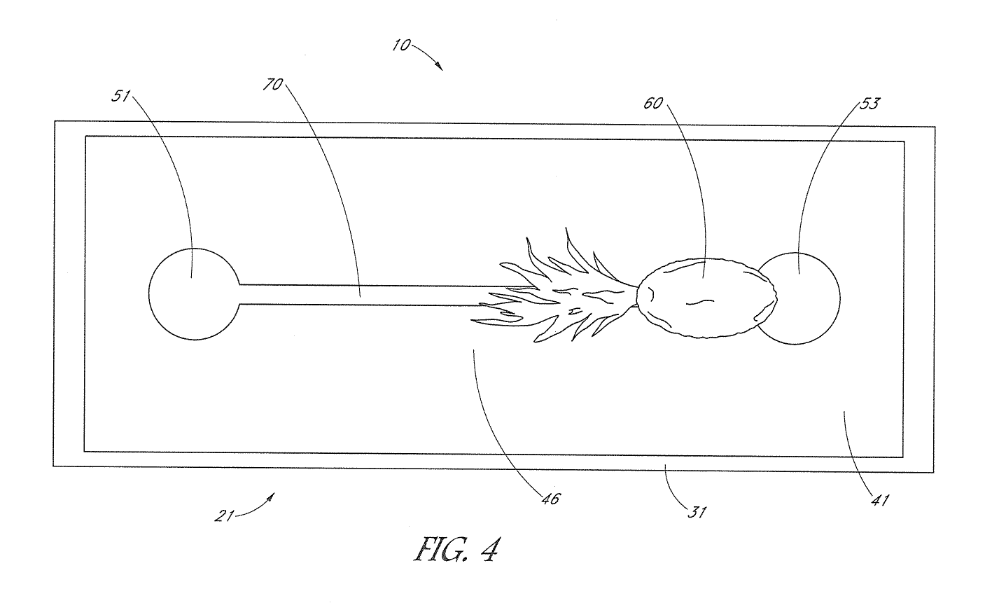

FIGS. 2-4 show an automated pet toy 10 with a base 21 similar to that in FIG. 1. In the present embodiment, the base 21 embodies a box 31 having a scratching pad 41, which can include an over layer made from one or more of the disclosed materials. The box 31 can include multiple sides and one or more sides of the box 31 can be covered by an over layer, similar to the automated pet toy of FIG. 1. The multiple sides can simply be called a first side or wall, a second side or wall, etc. and are not structurally limiting unless the context indicates otherwise. In the present embodiment, two holes 51, 53 are provided through the top surface 46 of the box 31 and connected to one another by a slot or channel 70. The top surface may be called a first wall. Generically speaking, the two holes 51, 54 and the slot or channel 70 on the top wall of the housing may be called an opening. The perimeter defining the opening may have a specific contour to produce a desired opening shape, such as one having two round surfaces connected to one another by a channel. The slot or channel 70 can be generally straight or linear and can have a gap opening size that is sufficient to at least accommodate a moving attachment member. The holes 51, 53 can be similar to the hole 50 of FIG. 1. The slot 70 provides space or room for a tether securing the toy object 60, the toy object itself, or both the tether and the toy object to traverse between the two holes. As shown, the toy object 60 emerges from the first hole 51 and moves from the first hole 51 along the slot 70 to the second hole 53 through which the toy 60 then moves back into the box 31, disappearing from view, as shown in FIGS. 3 and 4. In an example, the toy object 60 is moved by a drive mechanism, such as a motor. In another example, the toy object is moved by a motor that drives a belt, which then drives the toy between different parts of the toy housing, such as between the first hole and the second hole. In an example, the motor drives an attachment member that moves a toy or drives a belt that drives the attachment member that then moves the toy. The attachment member 62 can be a tether, which can be a wire, a coil spring, or a rope, and can be used to move the toy object 60 when directed on the other end by a motor. The attachment member can be a single piece or made from two or more pieces.

In an example, a belt, track or continuous band of threads is used to traverse the toy object 60 between two spaced apart points, such as between the first hole 51 and the second hole 53. An inside face of the track can engage a gear or wheel (not shown) at each end of the closed loop track or continuous band of treads, similar to a toy tank. Like the continuous track of a toy tank, upper and lower band sections of the continuous track can move along two generally parallel paths in between at least two gears or two wheels. If more than two gears or wheels are used, the band sections move along the two outer most wheels and are supported in between the two end wheels by the other wheel(s), if any. One of the gears or wheels is coupled to a motor (not shown), which drives the wheel and thereby the continuous band of track. Together in one embodiment, the continuous track, gear or wheel, and motor form a drive system (not shown). In some examples, reduction gears or increasing gears may be used to change the speed of the traversing wheel and therefore the continuous band.

In some embodiments, the drive system is configured such that it has a glitchy or intermittent operation, causing the toy 60 to have a jerk in its movement. Alternatively or in addition thereto, the tether can be selected to flex to cause the glitch or intermittent motions. The motor can be electrically powered, either by battery or by alternating current from a wall plug. An on/off switch can be provided on one of the sides of the toy housing to power up the automated toy assembly. In other examples, a pulley system is used with a motor and a gear reduction system to move the toy object along a track to traverse between the first hole 51 and the second hole 53. Other moving mechanisms may be used to move the toy object 60 between two spaced apart points, such as between the first hole 51 and the second hole 53. For example, a motorized inverse pendulum can be used to rotate a tether between an arc length. The tether is pivotable about a single rotatable axis and the toy object 60 is fixed to an end opposite the rotatable axis to be moved about an arc length.

FIGS. 5-8 show an automated pet toy 10 provided in accordance with further aspects of the present disclosure, which is similar to other automated toys discussed elsewhere herein with a few exceptions. As shown, a cuboid shaped toy housing 32 is mounted on a base 20. The toy housing 32 is covered in an over layer, such as carpet or other materials, that may serve as a scratching pad 40. In other examples, the toy housing 32 has a different shape, such as a rectangular prism. The base 20 has a generally planar surface 36 which surrounds the lower part or bottom of the toy housing 32, providing an easy transition from the floor to the base 20 for a pet to play with the toy object.

Contained within the base 32 is a drive mechanism, which can include a motor (not shown) with a cam attachment (not shown). The cam attachment can connect to one end of an attachment member 62, which can be a tether. On the opposite end, the attachment member 62 can connect to a visually attractive lure 60 to attract a pet's interest. An upper portion of the member 62 protrudes through a slot 70 provided in the top of the toy housing 32. The cam attachment causes the visually attractive lure 60 to move in an erratic, but repeatable pattern between two ends of the slot. In some examples, the drive system for moving the member 62 to move the toy object 60 has a motion of an inverse pendulum. When moved with an inverse pendulum pattern, the slot 70 can instead embody a single hole or opening, such as a round hole. In yet other examples, the attachment member 62 can be mounted directly or indirectly to an offset pivot pin or an offset cam rod to create both a rotary motion and a displacement motion. In some examples, the slot 70 is replaced with a single hole, having a shape described elsewhere herein, and the attractive lure 60 simply moves from a position inside the toy housing 32 to a position at least partially or completely outside of the toy housing by moving through the hole from the position inside the housing 32 and vice-versa. For example, the attractive lure 60, which an embody a mouse or other animals or objects, can simply move up-and-down out through the hole and back into the hole, such as along a single “Y” axis or vertical axis.

FIG. 5 shows an arbitrary starting point 75 of the toy object 60 relative to the slot 70 and to the moving pattern, which can instead be any point along the slot 70. The starting point 75 has been selected to describe an exemplary moving pattern of the toy object 60. At the arbitrary starting point 75 of FIG. 5, the visually attractive lure 60 is at a certain elevation relative to the generally planar surface 37 of the base. As shown, the visually attractive lure 60 is closest to a left-most point 35 of the slot 70 of the toy housing 32, from the perspective of FIG. 3, with a majority of the attachment member 62 located inside the toy housing 32. The slot 70 can be generally linear and can have a slot gap that is sufficient to at least accommodate a moving attachment member. The ends of the slot 70 can be a normal rounded end or can be enlarged from the size of the gap of the channel. In some examples, the slot can be curved or have a complex path. A flexible attachment member can bend and move through the curved or complex path. The slot 70 can generally be called an opening located on the top wall of the toy housing for accommodating the attachment member.

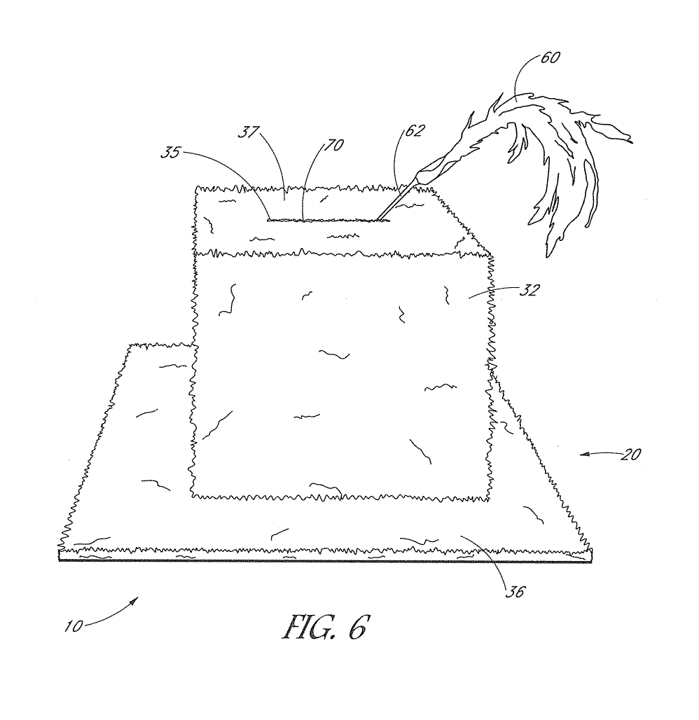

As shown in FIG. 6, when the drive mechanism inside the toy housing rotates, the attachment member 62 is moved around a pivot (not shown) at the connection of the member 62 with the drive mechanism from the left-most end or point 35 of the slot 70 to a right-most end or point 92 of the slot 70, with the visually attractive lure 60 remaining at approximately the same height or elevation relative to the generally planar surface 36 of the base 20, as that shown in FIG. 5.

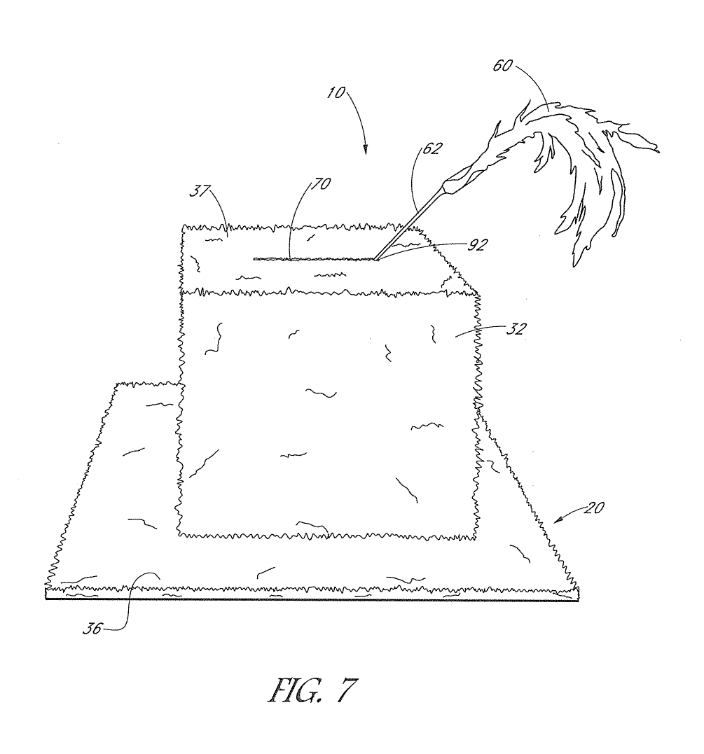

As shown in FIG. 7, further rotation of the drive mechanism inside the toy housing 32 causes the attachment member 62 to rise, extending upward through the slot 70 and exposing more of the attachment member outside the toy housing. The visually attractive lure 60 remains at the right end 92 of the slot 70, but has moved farther above or away from the top 37 of the toy housing 32, as compared to the distance from the top 37 in FIGS. 5 and 6. The vertical motion can be carried out by using a cam, an offset pin with slotted follower, a linkage system, or any conventional means in the art.

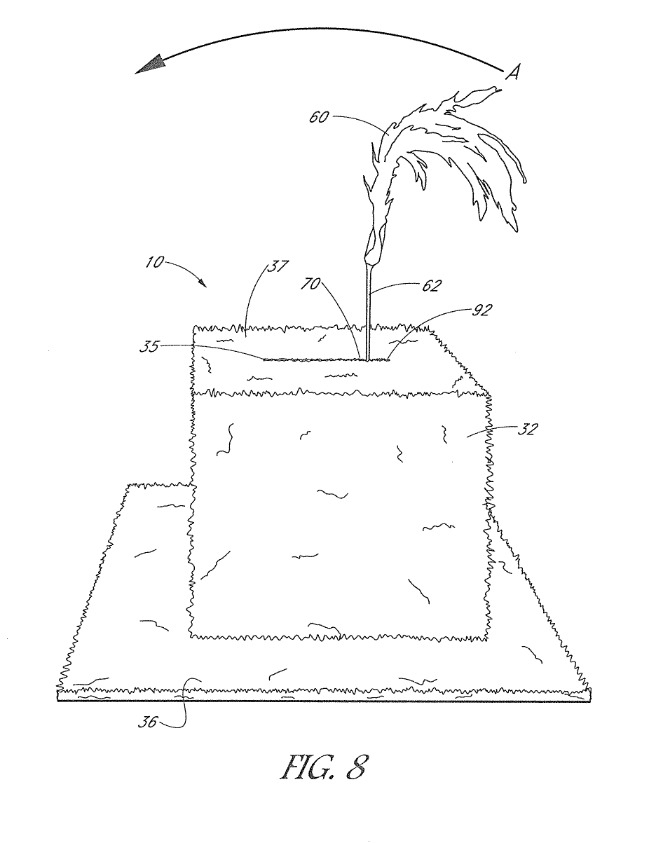

As shown in FIG. 8, the attachment member 62 begins to rotate around a pivot point (not shown) inside of the toy housing 32 back to the left-most point 35 as shown by the direction of the arrow A. Simultaneously, the member 62 is displaced along a vertical position relative to the generally planar surface of the base and/or the top surface 37, placing the visually attractive lure 60 at its highest point above the top surface 37 with the attachment member 62 being generally away from the ends of the slot 70 when the member 62 reaches the vertical position on the drive mechanism. From this position, the member 62 continues to pivot from right to left; from the perspective of FIG. 8, and partially retracts within the toy housing 32. Thus, the member 62 and the visually attractive lure 60 return to the starting point shown in FIG. 5. The automated pet toy 10 can repeat this pattern as long as power is applied to the motor (not shown). The motion of the toy object or visually attractive lure 60 can further be modified by incorporating a flexible attachment member, which flexes as it moves to induce additional motions to the toy object.

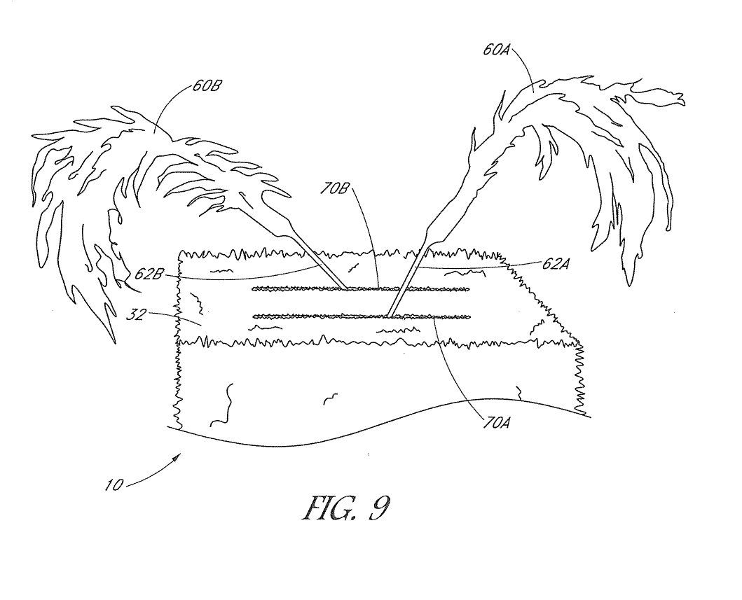

FIG. 9 shows an alternative automated pet toy 10 in accordance with further aspects of the present disclosure. The automated pet toy 10 is similar to the embodiment of FIGS. 5-8. In the present embodiment, the toy housing 32 comprises two visually attractive lures 60A, 60B. Correspondingly, the present toy housing 32 includes two attachment members 62A, 62B protruding through two slots 70A, 70B formed with the top surface 37 of the toy housing 32. Each member 62A, 62B connects to its own drive system, which includes one or more motors (not shown) and one or more cams, gears, and/or pivoting pins to move the attachment members. Each drive mechanism can be different than the other drive mechanism, thereby causing the attachment members 62A, 62B to move in different patterns to thereby move the visually attractive lures 60A, 60B in different patterns. The cams can also be the same but positioned out of sync to create different moving patterns. In some examples, rather 70A, 70B, the toy housing can incorporate two openings, such as two generally round holes, for the two attachment members 62A, 62B to move about.

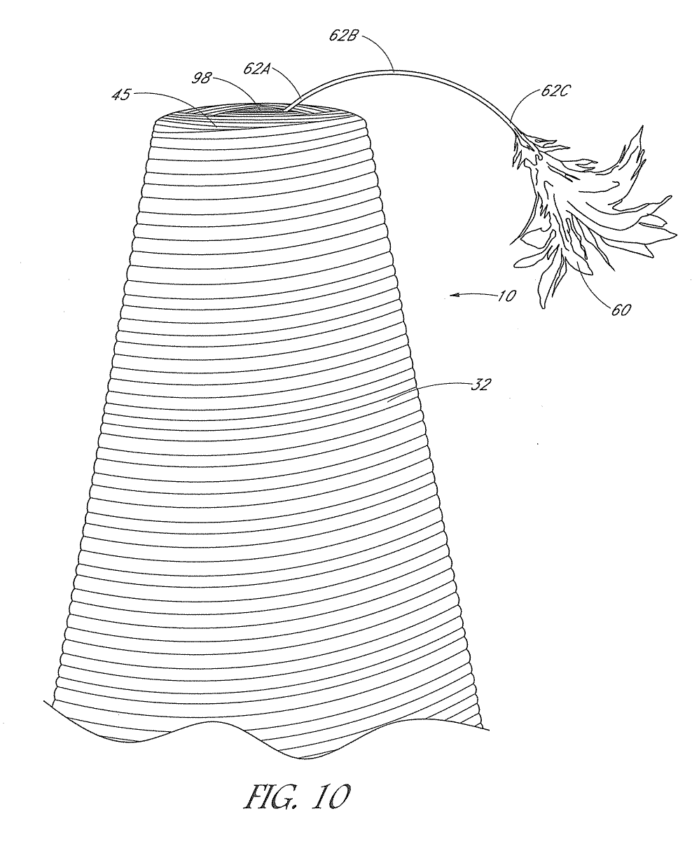

FIG. 10 shows another automated pet toy 10 provided in accordance with further alternative aspects of the present disclosure. In present embodiment, the toy housing 32 is conically shaped and covered with sisal rope. The toy housing can have a base diameter and a height selected for use as an automated toy. In an example, the base diameter of the toy housing can be between 5 inches to about 12 inches in diameter and about 6 inches high to about 12 inches high. In other examples, the toy housing can be larger or smaller than the disclosed range. The toy housing 32 can be made from a number of sturdy materials, such as hard plastic, and has an interior cavity for accommodating a drive mechanism and a power source or power adaptor for use with an external power source. The toy housing 32 can be used with or without a base comprising a generally planar surface. One or more access panels, for example at the bottom of the toy housing, can be provided for installation of internal components and for the power supply. The sisal rope can be wrapped around the exterior of the toy housing as a single continuous length or from several different lengths. The sisal rope can be more permanently secured to the toy housing with adhesive or other bonding means.

An attachment member 62, which can be flexible or semi-rigid to provide deflection, protrudes through a hole 98 at the top 45 of the toy housing 32. The weight of the visually attractive lure 60 causes the attachment member 62 to bend, giving the member an arched configuration with some tether portions 62B of the member 62 curving above the horizontal and some tether portions 62A, 62C of the member curving below the horizontal. The drive system (not shown) in this embodiment causes the member 62 to move in a primarily circular motion. However, because the attachment member 62 can flex or bend, it not only moves in a circular pattern but also displaces up and down due to the weight of the toy object 60 suspended at or near a free end of the attachment member. The toy object 60 in the present embodiment can resemble a bird. The jerking motion of the toy member 60 gives the impression of a small bird flapping its wings and flying around in a circle.

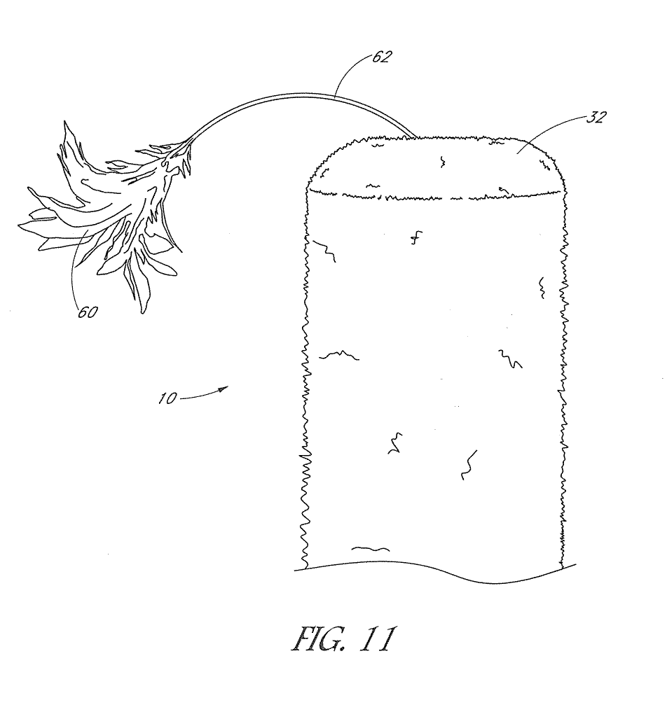

FIG. 11 shows an alternative automated pet toy 10 provided in accordance with further aspects of the present disclosure. The present automated pet toy 10 is similar to the automated pet toy embodiment of FIG. 10. In the present embodiment, the toy housing 32 is generally cylindrical and covered in carpet. The toy housing 32 can be attached to a base having a generally planar surface to provide a large and stable base for the housing. The toy housing 32 comprises a cavity having a drive system and a battery source for energizing the drive system, which drives an attachment device 62 and the attachment device moves the toy object 60, which can simulate a bird.

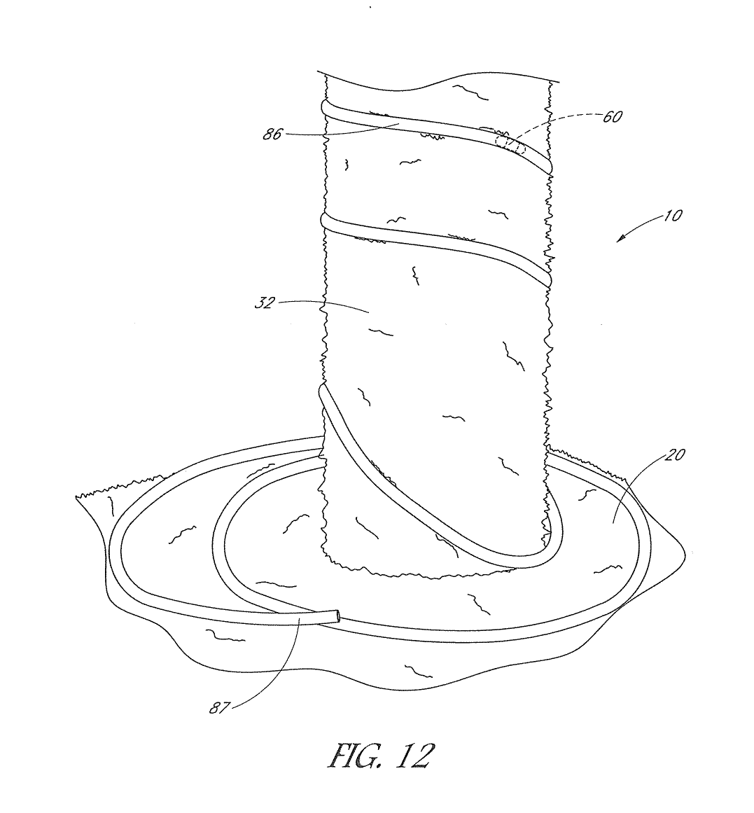

FIG. 12 shows yet another embodiment of an automated pet toy 10 provided in accordance with further aspects of the present disclosure. In the present embodiment, a tubing 86 is wrapped around a carpeted toy housing 32, which is mounted on a base 20. The toy housing 32 can have a number of different shapes. As shown, the toy housing has a cylindrical shape having a cavity for optionally accommodating a drive system and a power source. The drive system and power source can be used to move a tether and a toy object connected to an end of the tether, similar to other automated toys. Inside the tubing 86 is a visually attractive lure 60 that can be moved through the tubing 86 using air pressure. Thus, the tubing 86 can be transparent so that the visually attractive lure 60 can be seen through the tubing walls.

An end 87 of the tubing 86 is connected to an air pump (not shown). In some examples, the air pump can be provided in the interior space of the toy housing and an air pump output connection is provided near the base 20 for connection to the tubing 86 to supply pressurized air to the tubing. In other examples, the air pump is external to the toy housing. When the air pump is activated, it increases the air pressure inside the tubing 86 between the end 87 of the tubing 86 to which the air pump is connected and the visually attractive lure 60, causing the visually attractive lure 60 to rise through the tubing 86. The other end of the tubing 86 not connected to the air pump can be equipped with a vented cap that permits air to escape but not the visually attractive lure 60. When the air pump is deactivated or pressure is purged from the tubing, the visually attractive lure 60 moves downward or return through the tubing 86 due to gravitational forces. The visually attractive lure 60 can be made of any material that has a close fit with the interior tubing surface of the tubing 86 to enable sufficient pressure build-up to push the visually attractive lure 60 through the tubing. A pliable elastic material can be one such material. The visually attractive lure 60 should be brightly colored so that it will contrast with the typical colors used in base covering materials.

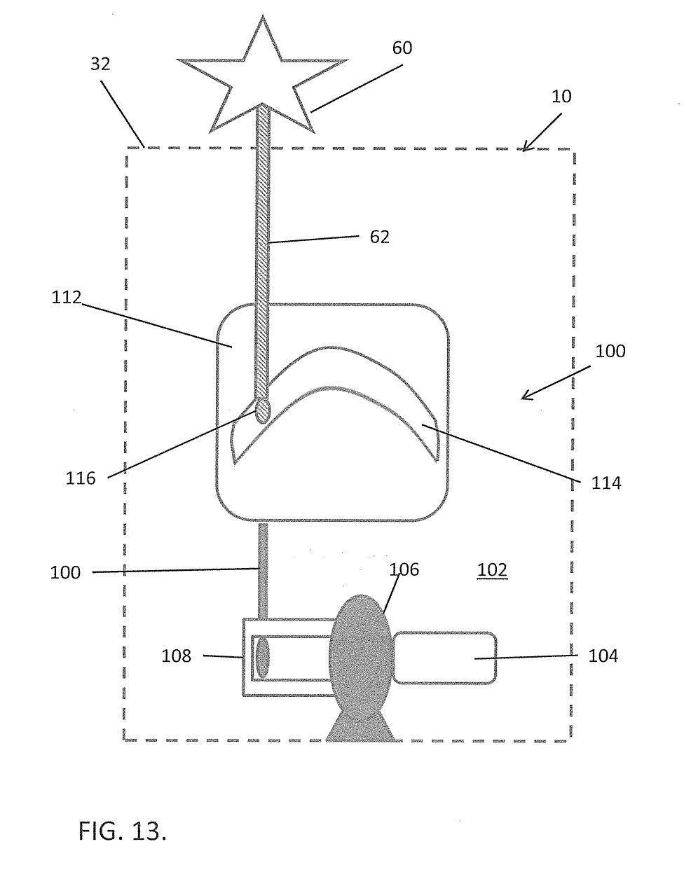

FIG. 13 is a schematic diagram showing an automated pet toy 10 comprising a housing 32 and a drive system or drive mechanism 100 located inside an interior cavity 102 of the housing 32. As previously described, the automated pet toy 10 can include a drive mechanism for moving an attachment device 62 that then moves a visually attractive lure or pet toy 60. The drive mechanism 100 can include a power source 104 for energizing a motor 106. In the present embodiment, the motor 106 can be connected to a drive box 108, which can include gears and a drive shaft for moving a rocker arm 110. The rocker arm 110 is in turn connected to a cam 112, which has a cam surface 114 in the form of a cam slot. The cam slot 114 confines a drive pin 116 to move within the path defined by the cam slot 115. An attachment member 62, which can be considered a tether, connects to the drive pin 116. Thus movement of the drive pin also moves the attachment member. The attachment member 62 is in turn connected to a visually attractive lure or pet toy 60, which can embody any shape or simulate any object or animal discussed elsewhere herein. Movement of the attachment member 62 causes the visually attractive lure 60 to move. Movement can be initiated by activating a switch, which turns on power to the drive mechanism. In some examples, as previously disclosed, the drive mechanism is sized and shaped to move the attachment member generally along a single plane or single axis. For example, the drive mechanism can move the attachment member straight up and straight down, with reference to FIG. 13.

Although limited embodiments of the automated pet toy assemblies and their components have been specifically described and illustrated herein, many modifications and variations will be apparent to those skilled in the art. For example, the various automated pet toys may incorporate other non-automated visually attractive lures, etc. Furthermore, it is understood and contemplated that features specifically discussed for one automated pet toy embodiment may be adopted for inclusion with another automated pet toy embodiment, provided the functions are compatible. For example, a visually attractive lure attached to a member may be used in another embodiment shown with a visually attractive lure attached to a track. Another example includes attaching a track mounted visually attractive lure to the side of a base, and a different visually attractive lure to the top. Another example includes using different housing shapes, different scratch pad materials, and different drive mechanisms. Accordingly, it is to be understood that the automated pet toy assemblies and their components constructed according to principles of the disclosed device, system, and method may be embodied other than as specifically described herein. The disclosure is also defined in the following claims.

What is claimed is:

1. An automated pet toy comprising:
a housing having an interior cavity defined by a first wall and a second wall located in opposing relationship to the first wall, which has an opening;
a drive mechanism located inside the interior cavity;
an attachment member connected, directly or indirectly, to the drive mechanism to be moved by the drive mechanism; said attachment mechanism passing through the opening of the first wall and having a section including a free end located inside the interior cavity and a section located external of the interior cavity above the opening; and
a lure connected to the free end of the attachment member to be moved by the attachment member.

2. The automated pet toy of claim 1, wherein the opening can be a slot, a slot connected to a hole having a dimension larger than the slot, or a hole having at least one of a round shape, an oval shape, an irregular shape, and a polygonal shape.

3. The automated pet toy of claim 1, wherein the attachment mechanism has a motion pattern that is along a single axis, along a single plane, or along a circular path.

4. The automated pet toy of claim 3, wherein the attachment mechanism is flexible and has a vertical displacement pattern.

5. The automated pet toy of claim 1, wherein the lure is disconnectable and connectable to the attachment device.

6. The automated pet toy of claim 1, wherein the lure has one or more feathers.

7. The automated pet toy of claim 1, wherein the housing has a scratching pad on an exterior surface.

8. The automated pet toy of claim 7, wherein the scratching pad is made from at least one of carpet, sisal rope, rubber mat, and cardboard material.

9. The automated pet toy of claim 1, wherein the second wall is a base having a generally planar surface.

10. The automated pet toy of claim 1, wherein the opening is a first opening and further comprising a second opening spaced from the first opening and a second lure connected to a second attachment member, which has a section extending through the second opening.

11. A method of using an automated pet toy comprising:
activating a switch to turn on power to a drive mechanism located inside an interior cavity of a toy housing having an opening on a first wall;
said driving mechanism driving, directly or indirectly, an attachment member having a section including a free end located inside the interior cavity and a section located external of the interior cavity above the opening;
said attachment member moving a lure connected to the free end of the attachment member; and
wherein said lure moves along a single axis, along a single plane, along a circular path, or combinations thereof.

12. The method of claim 11, further comprising presenting the automated pet toy to a household pet.

13. The method of claim 11, wherein the lure is a first lure and the method further comprising removing the first lure from the attachment member and connecting a second lure to the attachment member.

14. The method of claim 11, wherein the attachment member is a tether and wherein the tether is flexible and displaces the lure in a vertical direction.

15. The method of claim 11, wherein the housing has a scratching pad on an exterior surface.

16. The method of claim 11, wherein the opening can be a slot, a slot connected to a hole having a dimension larger than the slot, or a hole having at least one of a round shape, an oval shape, an irregular shape, and a polygonal shape.

17. The method of claim 15, wherein the scratching pad is made from at least one of carpet, sisal rope, rubber mat, and cardboard material.

18. The method of claim 11, wherein the drive mechanism comprises a cam.

19. The method of claim 11, wherein the lure comprises a feather.

20. An automated pet toy comprising:
a housing having an interior cavity defined by a first wall and a second wall located in opposing relationship to the first wall, which has an opening comprising a hole;
a drive mechanism located inside the interior cavity comprising a batter operated motor;
an attachment member connected, directly or indirectly, to the drive mechanism to be moved by the drive mechanism; said attachment mechanism having a section including a free end located inside the interior cavity and a section located external of the interior cavity above the opening;
a lure simulating an animal connected to the free end of the attachment member to be moved by the attachment member; and
wherein the drive mechanism is sized and shaped to move the lure generally along a single plane or a single axis to move the lure at least partially out of the hole from the interior cavity and at least partially into the interior cavity.
